(19) United States
(12) Patent Application Publication
(10) Pub. No.: US 2013/0264286 A1
(43) Pub. Date: Oct. 10, 2013

(54) BIOLOGICAL SAMPLE FILTERING SYSTEM AND METHOD FOR FILTERING BIOLOGICAL SAMPLES

(71) Applicant: CELLS SCIENTIFIC CORPORATION, Taipei City (TW)

(72) Inventor: Chi-Sheng Tai, Taipei City (TW)

(73) Assignee: Cells Scientific Corporation, Taipei City (TW)

(21) Appl. No.: 13/845,872

(22) Filed: Mar. 18, 2013

(30) Foreign Application Priority Data
Apr. 6, 2012 (TW) 101112304

(51) Int. Cl. B01D 65/02

(52) U.S. Cl. CPC B01D 65/027
USPC 210/636; 210/257.2; 210/97; 210/650

(57) ABSTRACT

A biological sample filtering system for filtering biological liquid samples includes: a sample-mounting box; a plurality of column units disposed in sample wells in the sample-mounting box; a filtrate-collecting container; a control valve connected to the sample-mounting box and the filtrate-collecting container; and a vacuum pump connected to the filtrate-collecting container for generating a vacuum in the box chamber that permits a liquid in the biological liquid samples to be flushed from the column units into the filtrate-collecting container.

### CROSS-REFERENCE TO RELATED APPLICATION

This application claims priority of Taiwanese application no. 101112304, filed on Apr. 6, 2012.

### BACKGROUND OF THE INVENTION

1. Field of the Invention

This invention relates to a biological sample filtering system and a method of filtering biological liquid samples, more particularly to a biological sample filtering system capable of flushing a liquid in the biological liquid samples through membrane members and into a filtrate-collecting space.

2. Description of the Related Art

WO 2010/075116 discloses a biological sample filtering system that includes a base having two or more vacuum chambers, a top plate mounted detachably on the base, and a plurality of sample columns mounted on the top plate and provided with membrane members, respectively. Each of the sample columns receives a biological liquid sample containing a liquid and substances, such as DNAs, RNAs, and proteins, to be separated from the liquid for subsequent analysis or experiment. In addition, the liquid is normally contaminated with impurities, such as water-soluble or water-insoluble substances. The biological sample filtering system is connected to a vacuum pump that can generate a negative pressure in the vacuum chambers for withdrawing the liquid and the impurities in the biological liquid sample to pass through the membrane member and into the vacuum chambers, thereby separating the substances apart from the liquid and the impurities.

The Applicant found that the aforesaid biological sample filtering system is disadvantageous in that since the sample columns may receive different types of the biological liquid samples and since the biological liquid samples received in some of the sample columns may have very few and small solid impurities while the biological liquid samples received in others of the sample columns may have many large sizes and sticky impurities, the biological liquid samples in said some of the sample columns are filtered much faster than those in said others of the sample columns when vacuum starts being generated in the vacuum chambers. It can occur at a point in time that the filtration in said some of the sample columns is finished and environmental air starts being drawn through the semi-permeable membrane members in said some of the sample columns and into the vacuum chambers while the filtration in said others of the sample columns is not yet finished. As a consequence, the vacuum pump cannot reduce the pressure in the vacuum chambers to a desired vacuum level to provide a satisfactory filtering rate for the biological liquid samples in said others of the sample columns, which results in an increase in the filtering time. In addition, pores in the semi-permeable membrane members tend to get clogged with the impurities when the filtering rate is too slow, which worsens the filtering rate and which undesirably leaves the impurities with the substances on the semi-permeable membrane members in said others of the sample columns.

### SUMMARY OF THE INVENTION

Therefore, an object of the present invention is to provide a biological sample filtering system that can overcome the aforesaid drawbacks associated with the prior art.

According to one aspect of this invention, there is provided a biological sample filtering system for filtering biological liquid samples each of which contains a liquid, impurities and substances to be separated from the liquid and the impurities. The biological sample filtering system comprises: a sample-mounting box that defines an enclosed box chamber and a fluid outlet in fluid communication with the box chamber and that has an upper manifold formed with a plurality of sample wells in fluid communication with the box chamber; a plurality of column units, each of which is disposed in a respective one of the sample wells, each of which is adapted to receive one of the biological liquid samples, and each of which has a tube member and a membrane member mounted in the tube member for filtering the substances in the biological liquid samples, the tube member being in fluid communication with the respective one of the sample wells; a filtrate-collecting container defining a filtrate-collecting space and having a fluid inlet and an air outlet, the filtrate-collecting space being in fluid communication with the fluid inlet and the air outlet; a control valve disposed between and connected to the fluid outlet of the sample-mounting box and the fluid inlet of the filtrate-collecting container for controlling fluid communication between the box chamber and the filtrate-collecting space; and a vacuum pump connected to the air outlet of the filtrate-collecting container and capable of generating a vacuum in the filtrate-collecting space when the control valve is closed so as to generate a vacuum in the box chamber when the control valve is subsequently opened and to permit the liquid together with the impurities in the biological liquid samples to be flushed from the column units through the membrane members and the box chamber and into the filtrate-collecting space.

According to another aspect of this invention, there is provided a method of filtering biological liquid samples each of which contains a liquid, impurities and substances to be separated from the liquid and the impurities using a biological sample filtering system that includes a sample-mounting box, a filtrate-collecting container, a control valve disposed between and connected to the sample-mounting box and the filtrate-collecting container, and a vacuum pump connected to the filtrate-collecting container. The sample-mounting box defines a box chamber and a plurality of sample wells in fluid communication with the box chamber. The filtrate-collecting container defines a filtrate-collecting space. The method includes: (a) disposing a plurality of column units in the sample wells, respectively, each of the column units having a tube member and a membrane member mounted in the tube member for filtering the substances in the biological liquid samples; (b) prevacuuming the filtrate-collecting space to a preset pressure while the control valve is closed to prevent fluid communication between the box chamber and the filtrate-collecting space; and (c) opening the control valve after step (b) to permit fluid communication between the box chamber and the filtrate-collecting space so as to generate instantly a vacuum in the box chamber that permits the liquid together with the impurities in the biological liquid samples to be flushed from the column units through the membrane members and the box chamber and into the filtrate-collecting space.

### BRIEF DESCRIPTION OF THE DRAWINGS

In drawings which illustrate an embodiment of the invention,

FIG. 1 is a fragmentary perspective view of the preferred embodiment of a biological sample filtering system according to the present invention;

FIG. 2 is a fragmentary sectional view of the preferred embodiment;

FIG. 3 is a fragmentary perspective view illustrating a mechanical structure of a control valve of the preferred embodiment;

FIG. 4 is a perspective view of the control valve of the preferred embodiment; and

FIG. 5 is a flow chart of a method of filtering the biological liquid samples using the preferred embodiment.

### DETAILED DESCRIPTION OF THE PREFERRED EMBODIMENT

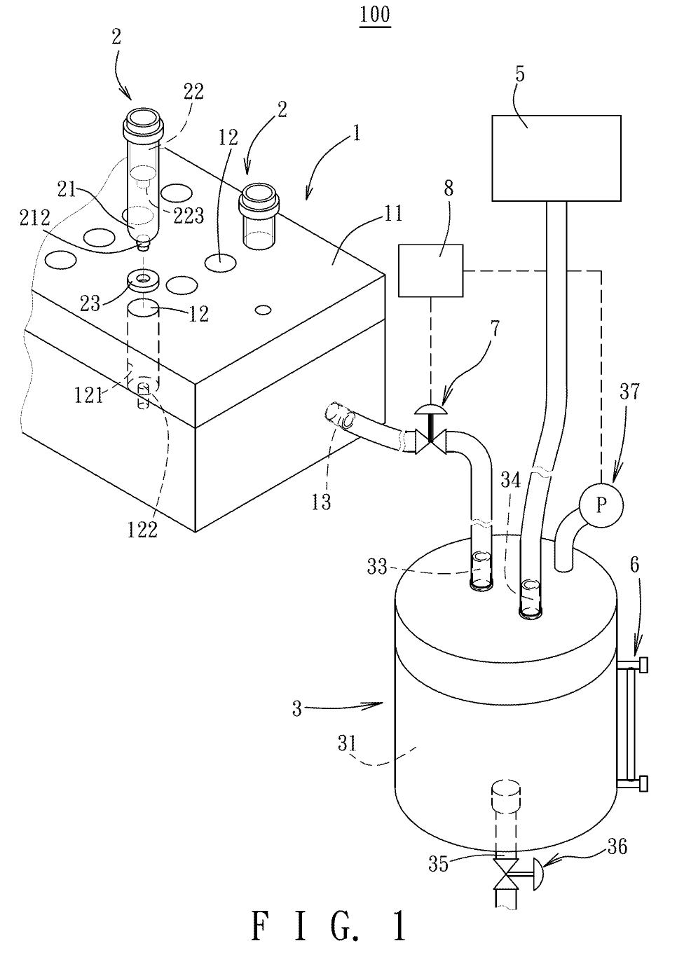

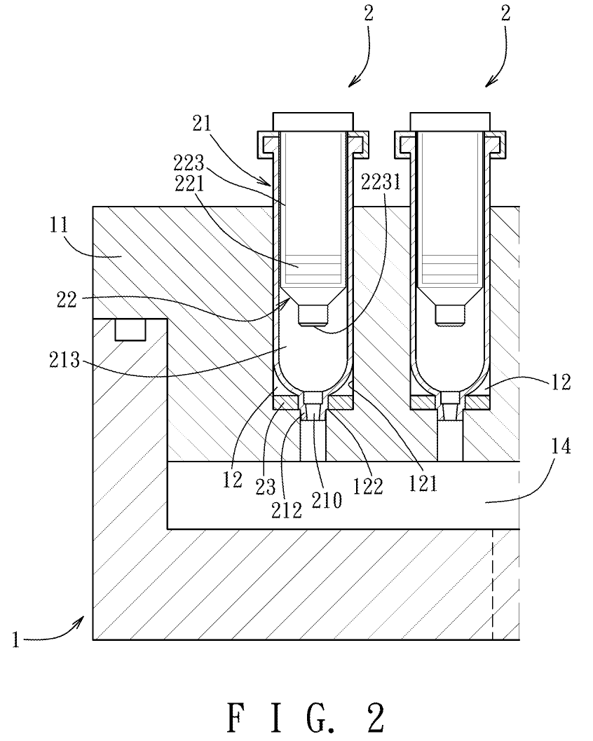

FIGS. 1 and 2 illustrate the preferred embodiment of a biological sample filtering system 100 for filtering biological liquid samples (not shown) according to the present invention. Each of the biological liquid samples contains a liquid, impurities, and substances, such as DNAs, RNAs, and proteins, to be separated from the liquid and impurities. The impurities may be water-soluble substances, water-insoluble substances, sticky materials or large molecules.

The biological sample filtering system 100 includes: a sample-mounting box 1 that defines an enclosed box chamber 14 and a fluid outlet 13 in fluid communication with the box chamber 14 and that has an upper manifold 11 formed with a plurality of sample wells 12, each of the sample wells 12 being defined by a well-defining wall 121 that has a bottom opening 122 in fluid communication with the box chamber 14; a plurality of column units 2, each of which is disposed in a respective one of the sample wells 12, each of which is adapted to receive one of the biological liquid samples, and each of which has a tube member 21 and a membrane member 22 mounted in the tube member 21 for filtering the substances in the biological liquid samples, the tube member 21 having a bottom hole 210 in fluid communication with the bottom opening 122 in the well-defining wall 121 of the respective one of the sample wells 12; a filtrate-collecting container 3 defining a filtrate-collecting space 31 and having a fluid inlet 33, an air outlet 34 and a bottom liquid drain 35, the filtrate-collecting space 31 being in fluid communication with the bottom liquid drain 35, the fluid inlet 33 and the air outlet 34; a drain valve 36 connected to the bottom liquid drain 35 for controlling draining of the liquid accumulated in the filtrate-collecting space 31; a control valve 7 disposed between and connected to the fluid outlet 13 of the sample-mounting box 1 and the fluid inlet 33 of the filtrate-collecting container 3 for controlling fluid communication between the box chamber 14 and the filtrate-collecting space 31; a vacuum pump connected to the air outlet 34 of the filtrate-collecting container 3 and capable of generating a vacuum in the filtrate-collecting space 31 when the control valve 7 is closed so as to generate a vacuum in the box chamber 14 when the control valve 7 is subsequently opened, thereby permitting the liquid together with the impurities in the biological liquid samples to be instantly flushed from the column units 2 through the membrane members 22 and the box chamber 14 and into the filtrate-collecting space 31; and a pressure detector 37 connected to the filtrate-collecting container 3 for detecting the pressure in the filtrate-collecting space 31 and operatively associated with the control valve 7 so that when the pressure in the filtrate-collecting space 31 reaches a preset pressure, the control valve 7 can be opened to permit fluid communication between the box chamber 14 and the filtrate-collecting space 31 and thus generate of the flushing action.

The volume of the box chamber 14 is normally less than one liter, and preferably ranges from 0.1 to 0.5 liter so that the size of the sample-mounting box 11 will not be too large and bulky for handling and for subsequent analysis operations. In addition, when the volume of the filtrate-collecting space 31 is too small, an extremely high vacuum in the filtrate-collecting space 31 (i.e., the preset pressure in the filtrate-collecting space 31 is required to be very low) is required for generating the flushing action, which can result in a considerable increase in the duty cycle of the vacuum pump 5. Hence, the volume of the filtrate-collecting space 31 is preferably greater than one liter and the volume ratio of the volume of the filtrate-collecting space 31 to the volume of the box chamber 14 is greater than 4:1, and more preferably, the volume ratio of the volume of the filtrate-collecting space 31 to the volume of the box chamber 14 is greater than 8:1. Since the volume of the box chamber 14 is relatively small, frequent manual operations of removing the filtrate accumulated in the box chamber 14 is required if the biological sample filtering system is without the filtrate-collecting container 3, which results in laborious works and inconvenient operations. Hence, the inclusion of the filtrate-collecting container 3 in the biological sample filtering system 100 permits alleviation of the laborious and inconvenient drawbacks. It is noted that the preset pressure in the filtrate-collecting space 31 is required to be sufficient to permit the pressure in the box chamber 14 to be reduced from the atmospheric pressure to less than 250 mmHg immediately after the control valve 7 is opened so as to generate the flushing action.

In this embodiment, the biological sample filtering system 100 further includes a liquid level detector 6 provided on the filtrate-collecting container 3 for detecting a liquid level of the liquid collected in the filtrate-collecting space 31, and a valve controller 8 connected to the pressure detector 37 and the control valve 7 so as to receive a pressure signal, that corresponds to the pressure in the filtrate-collecting space 31, from the pressure detector 37 and so as to control opening and closing of the control valve 7 based on the pressure signal.

Referring to FIG. 2, a plurality of elastic rings 23 are disposed at bottoms of the sample wells 12, respectively. Each of the tube members 21 has a bottom tubular protrusion 212 extending through a respective one of the elastic rings 23. Each of the membrane members 22 has an inner tube body 223 and a thin film-membrane 221 disposed in the inner tube body 223. The inner tube body 223 of each of the membrane members 22 is inserted into the respective one of the tube members 21, and has a bottom opening 2231 in fluid communication with an inner space 213 of the respective one of the tube members 21.

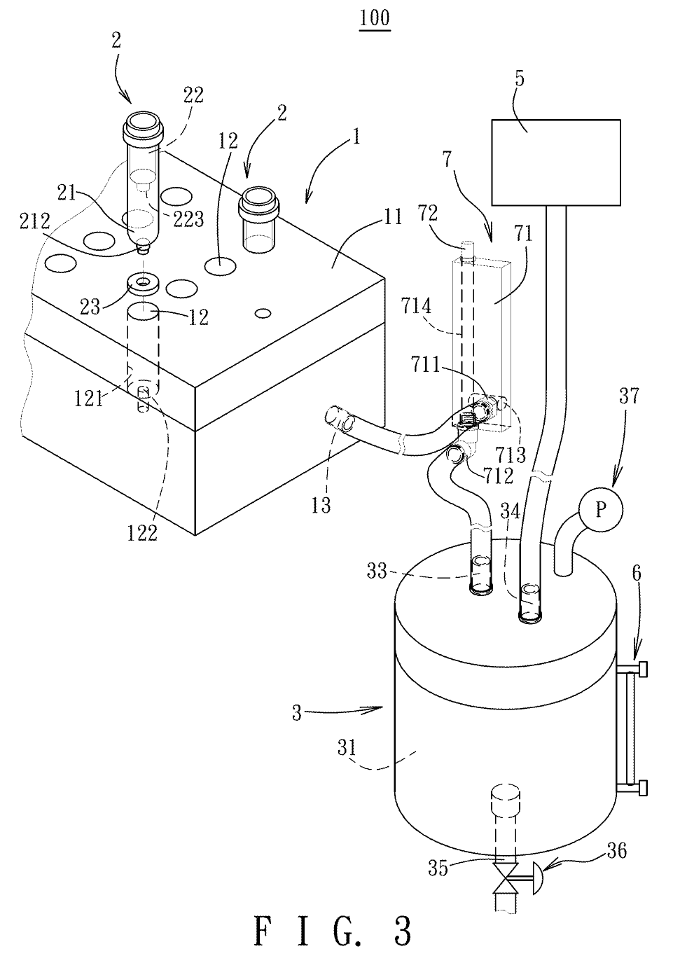

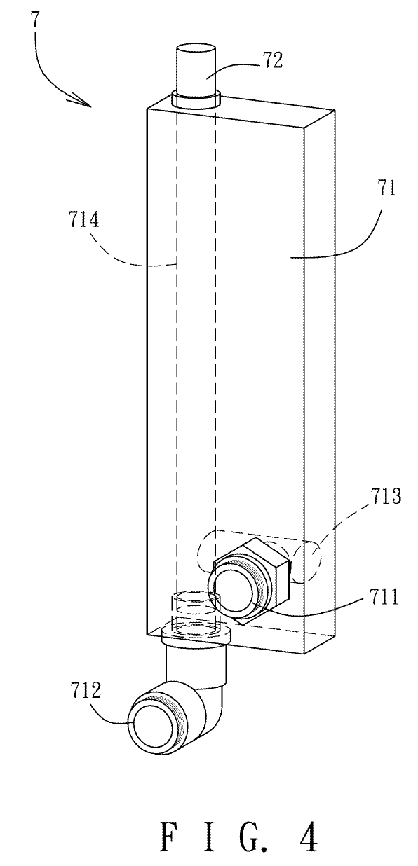

FIGS. 3 and 4 illustrate a mechanical structure of the control valve 7. The control valve 7 includes a valve body 71 and a valve rod 72. The valve body 71 is formed with an inlet port 711, an outlet port 712, a tortuous flow passage 713 in fluid communication with the inlet port 711 and the outlet port 712, and a rod-receiving hole 714 extending from an end of the valve body 71 to an end section of the flow passage 713. The valve rod 72 extends movably into the rod-receiving hole 714, and is movable into the end section of the flow passage 713 for preventing fluid communication between the inlet port 711 and the outlet port 712 and out of the end section of the flow passage 713 for permitting fluid communication between the inlet port 711 and the outlet port 712.

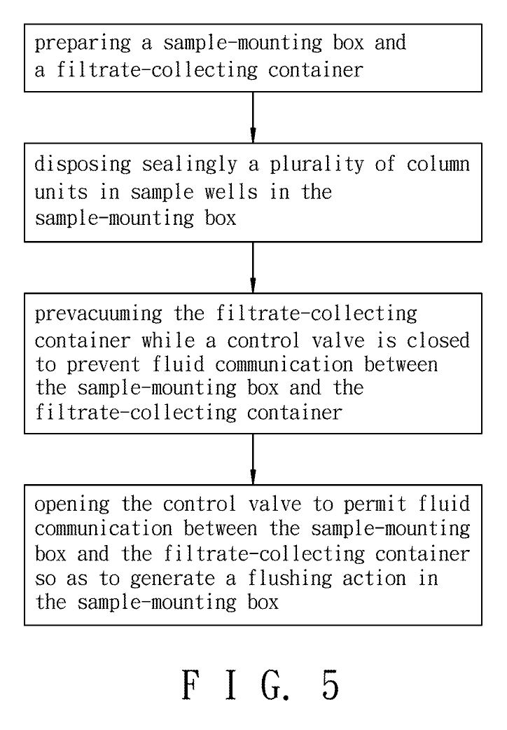

FIG. 5, in combination with FIGS. 1 and 2, illustrates a flow diagram of a method of filtering the biological liquid samples using the biological sample filtering system 100 of the present invention. The method includes the steps of: preparing the biological sample filtering system 100; disposing the column units 2, that respectively receive the biological liquid samples, in the sample wells 12, respectively; prevacuuming the filtrate-collecting space 31 to the preset pressure while the control valve 7 is closed to prevent fluid communication between the box chamber 14 and the filtrate-collecting space 31; and opening the control valve 7 after the prevacuuming step to permit fluid communication between the box chamber 14 and the filtrate-collecting space 31 so as to generate instantly a vacuum in the box chamber 14 that permits the liquid together with the impurities in the biological liquid samples to be instantly flushed from the column units 2 through the membrane members 22 and the box chamber 14 and into the filtrate-collecting space 31.

Preferably, the preset pressure in the filtrate-collecting space 31 permits the pressure in the box chamber 14 to be reduced from the atmospheric pressure to less than 250 mmHg, and more preferably to less than 160 mmHg, immediately after the control valve 7 is opened so as to generate the flushing action.

The design of the biological sample filtering system 100 of the present invention permits generation of the flushing action in the sample-mounting box 1 so that even when the biological liquid samples are obtained from different sources and contain different impurities (with different dimensions and stickiness), the liquid together with the impurities in the biological liquid samples in the column units 2 can also be instantly and simultaneously withdrawn into the box chamber 14, thereby overcoming the aforesaid drawbacks associated with the prior art.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A biological sample filtering system for filtering biological liquid samples containing a liquid, impurities, and substances to be separated from the liquid and the impurities, said biological sample filtering system comprising:
a sample-mounting box that defines an enclosed box chamber and a fluid outlet in fluid communication with said box chamber and that has an upper manifold formed with a plurality of sample wells in fluid communication with said box chamber;
a plurality of column units, each of which is disposed in a respective one of said sample wells, each of which is adapted to receive one of the biological liquid samples, and each of which has a tube member and a membrane member mounted in said tube member for filtering the substances in the biological liquid samples, said tube member being in fluid communication with the respective one of said sample wells;
a filtrate-collecting container defining a filtrate-collecting space and having a fluid inlet and an air outlet, said filtrate-collecting space being in fluid communication with said fluid inlet and said air outlet;
a control valve disposed between and connected to said fluid outlet of said sample-mounting box and said fluid inlet of said filtrate-collecting container for controlling fluid communication between said box chamber and said filtrate-collecting space; and
a vacuum pump connected to said air outlet of said filtrate-collecting container and capable of generating a vacuum in said filtrate-collecting space when said control valve is closed so as to generate a vacuum in said box chamber when said control valve is subsequently opened and to permit the liquid together with the impurities in the biological liquid samples to be flushed from said column units through said membrane members and said box chamber and into said filtrate-collecting space.

2. The biological sample filtering system of claim 1, wherein the volume ratio of the volume of said filtrate-collecting space to the volume of said box chamber is greater than 4:1.

3. The biological sample filtering system of claim 1, further comprising a pressure detector and a valve controller, said pressure detector being connected to said filtrate-collecting container for detecting the pressure in said filtrate-collecting space, said valve controller being connected to said pressure detector and said control valve so as to receive a pressure signal, that corresponds to the pressure in said filtrate-collecting space, from said pressure detector and so as to control opening of said control valve based on the pressure signal.

4. A method of filtering biological liquid samples containing a liquid, impurities and substances to be separated from the liquid and the impurities using a biological sample filtering system that includes a sample-mounting box, a filtrate-collecting container, a control valve disposed between and connected to the sample-mounting box and the filtrate-collecting container, and a vacuum pump connected to the filtrate-collecting container, the sample-mounting box defining a box chamber and a plurality of sample wells in fluid communication with the box chamber, the filtrate-collecting container defining a filtrate-collecting space, the method comprising:
(a) disposing a plurality of column units in the sample wells, respectively, each of the column units having a tube member and a membrane member mounted in the tube member for filtering the substances in the biological liquid samples;
(b) prevacuuming the filtrate-collecting space to a preset pressure while the control valve is closed to prevent fluid communication between the box chamber and the filtrate-collecting space; and
(c) opening the control valve after step (b) to permit fluid communication between the box chamber and the filtrate-collecting space so as to generate instantly a vacuum in the box chamber that permits the liquid together with the impurities in the biological liquid samples to be flushed from the column units through the membrane members and the box chamber and into the filtrate-collecting space.

5. The method of claim 4, wherein, in step (c), the pressure in the box chamber is reduced from the atmospheric pressure to less than 160 mmHg immediately after the control valve is opened so as to generate the flushing action.

6. The method of claim 4, wherein the volume ratio of the volume of the filtrate-collecting space to the volume of the box chamber is greater than 4:1.
